(19) United States
(12) Patent Application Publication
(10) Pub. No.: US 2011/0124772 A1
(43) Pub. Date: May 26, 2011

(54) ANTIMICROBIAL POLYMERS AND THEIR USES

(75) Inventors: Shanger Wang, Fairfield, CA (US); Robert S. Ward, Lafayette, CA (US); Yuan Tian, Alameda, CA (US); Li Li, Oakland, CA (US); Keith Mccrea, Concord, CA (US); James Parakka, San Bruno, CA (US); Robert L. Jones, JR., Oakland, CA (US)

(73) Assignee: DSM IP Assets B.V., Heerlen (NL)

(21) Appl. No.: 12/994,836

(22) PCT Filed: May 26, 2009
(86) PCT No.: PCT/US09/45140

§ 371 Date: Jan. 7, 2011

Related U.S. Application Data
(60) Provisional application No. 61/057,024, filed on May 29, 2008.

(51) Int. Cl. C09D 175/04; C08G 71/04

(52) U.S. Cl. 523/177; 525/453; 524/590

(57) ABSTRACT

Polymers with non-leaching antimicrobial activity and their use as surface coatings or bulk resins for medical devices. The antimicrobial polymers are prepared with antimicrobial moieties covalently bonded to a polymer chain end or to a polymer backbone at a side chain end. The antimicrobial moiety-containing endgroups include surface active (or surface assembling) moieties which promote enrichment of antimicrobial endgroups at the polymer surface and thus formation of an antimicrobially active surface. Polymers with built-in antimicrobial endgroups can be used as bulk resins, as antimicrobial additives, or as infection preventative coatings in the manufacture of medical devices (e.g., catheters, vascular access devices, peripheral lines, IV sites, drains, gastric feeding and tubes, and other implantable devices). Such materials can also be used as antimicrobial and antifouling coatings on structures in contact with microorganism in environments that require control of biofilm formation, such as marine products.

### FIELD OF THE INVENTION

The present invention provides novel polymers having antimicrobially active moieties covalently incorporated into their molecular structures. Also disclosed herein are novel useful medical devices and coatings made from such polymers.

### BACKGROUND OF THE INVENTION

Antimicrobials are chemical compounds which reduce or mitigate the growth or development of microbial organisms. This is achieved by a variety of mechanisms dependent upon the mode of action, composition, degree of activity, and application. The use of the antimicrobial compounds leads to either death or arrested growth of the targeted microorganisms. Since their discovery in the early 1900s, antimicrobial agents have transformed the prevention and treatment of infectious diseases. They are currently employed across a very broad spectrum of applications.

Antimicrobials are also potentially hazardous to human health. Therefore, it is desirable to have non-leaching antimicrobial materials which remain effective over the life of usage and which reduce the risk of creating adaptable resistant microorganisms. Ideally, the antimicrobial agents would have proven history of use and display broad spectrum activity against various microorganisms without adversely affecting patients' health. The antimicrobial material, or other materials containing the antimicrobial agent, should be applicable to a configured medical or other health care product surface by commercially-viable manufacturing methods such as molding, extrusion, and all other thermoplastic methods of ‘conversion’ or solvent-based processing, water-borne systems, and 100%-solids (crosslinkable) liquid. In addition, the antimicrobial additive should not interfere with physiochemical and mechanical properties of the treated material and must be applicable to existing formulations and manufacturing processes. Furthermore and importantly, the integration of new antimicrobial properties in products should be economical.

Bacterial infection is one of the common complications related to the use of medical devices. Advances in medical devices such as catheters, vascular access devices, peripheral lines, intravenous (IV) sites, drains, gastric feeding tubes, trachea tubes, stents, guidewires, pacemakers, and other implantable devices have enormously benefited the diagnostic and therapeutic practices in medical care. Unfortunately, however, bacterial infections are becoming one of the most serious complications related to the use of indwelling medical devices. For example, urinary-tract infection occurs in about 20% of patients with Foley catheters in place for more than 10 days and in more than 40% of patients with them in place for more than 25 days. Plott et al., “Mortality associated with nosocomial urinary-tract infection”, N. Eng. J. Med., 30(11):637 (1982). In addition, bacterial resistance to current antibiotic treatments has become a major health care issue around the world. Resistant strains continue to emerge and more antibiotics are prescribed to treat infection caused by artificial implants.

One common approach to reduce device-related infections is to develop surfaces with bactericidal activity by means of releasing antimicrobial compounds. Depending on the methods used to incorporate the antimicrobial agents, almost all common treatments fall into one of the following three categories: 1) adsorption of the antimicrobial agent to the surface of materials ether passively or in combination with surfactants or surface-bonded polymers; 2) incorporation of the agent into a polymer coating applied on the material surface; 3) compounding the agent into the bulk material comprising the device. Among these, perhaps the most common strategy involves the impregnation of antimicrobial agents into a polymer binder applied to the device surface. For example, U.S. Pat. No. 6,939,554 describes a cross-linkable polymer formulation that contains quaternary ammonium compounds, gentian violet compounds, substituted or unsubstituted phenols, biguanide compounds, iodine compounds, and mixture thereof as leachable active ingredients. U.S. Pat. No. 4,612,337 discloses a method for making the surface of a medical device antimicrobial by soaking the polymer material of the device with a solution of an organometallic compound dissolved in an organic solvent. The polymer material is then dried after washing. U.S. Pat. No. 7,306,777 describes a coating composition comprising an antimicrobial compound and a polyethylene-polyvinylalcohol copolymer as the binder, aiming to better control the release rate of active ingredients. Heavy metal ions such as zinc, copper, and silver are known to function as active antimicrobial leachables and have been used in coating and compounding compositions.

U.S. Pat. No. 4,973,320 describes a medical device made from a composition of organometallic compounds and a polyurethane elastomer having a silicone soft segment to control the releases of the metal ions over the length of usage.

The above approaches are based on the leaching mechanism of the active ingredient, whether it is an organic compounds or a metal ion. The antimicrobial efficacy of the antimicrobial surface is dependent on the concentration of the bioactive agent (loading) and the rate of its release from the surface. Whether the mode of release is dissolution or diffusion of the active ingredient into the contact media, or upon either hydrolysis or dissolution of the matrix containing an antimicrobial agent to effect its release into media, the amount of the active compounds leaching out has to be well-controlled. A non-controlled release could have significant impact to the health and safety of the user if it exceeds the toxicity level. Alternatively, it may not reach the minimum induction concentration (MIC) to be antimicrobial effective. In fact, a burst of initial high level bioactive component into the contacting media is usually observed, approaching a cytotoxic level of these compounds in immediate environment, followed by a rapid depletion resulting in the short-term antimicrobial efficacy. It is often very difficult to control the release rate and maintain a constant level of concentration at the surface as the release rate depends on many factors such as actual concentration, solubility, and diffusivity of these active ingredients in the bulk polymer which may also change over the time of use.

Piozzi et al., “Antimicrobial activity of polyurethanes coated with antibiotics: a new approach to the realization of medical devices exempt from microbial colonization”, International Journal of Pharmaceutics, 280 (2004), 173-183, and Ke'bir et al., “Use of telechelic cis-1,4-polyisoprene cationomers in the synthesis of antibacterial ionic polyurethanes and copolyurethanes bearing ammonium groups”, Biomaterials, 28 (2007), 4200-4208, provide additional relevant background.

From an economic view, an often complicated secondary step of manufacturing is required in order to apply the formulated coating to the surface. The additional steps required may affect the final product yield and product dimension. In addition to the added cost, in many cases an alteration of the existing surface may not be acceptable as their uses require precision dimension control, optical clarity, bulk homogeneity, or other surface requirements that may be important to the application. Furthermore, the extended use of drug release based products may have significant implications to the local environment. Heavy metals such as silver or mercury are known to be toxic to human cells at a very low concentration and have shown negative impact to the neurological and reproduction systems.

Immobilization of antimicrobial agents such as peptide has shown improved bactericidal stability, the effective amount of the active peptide on the surface has been limited due to the entrapment of the predominant peptide in the matrix. Haynie et al, “Antimicrobial activities of amphiphilic peptides covalently bonded to a water insoluble resin,” J. Antimicrob. Chemiother., 39:301, 1995. Cooper et al reported the preparation of polyurethanes with N,N-bis(2-hydroxyethyl)isonicotinamide (BIN) incorporated into the polymer hard segment during synthesis as a chain extender and subsequently converted a tertiary amine chain extender to a quaternary ammonium salt with alkyl halides. Cooper et al., “Synthesis and characterization of non-leaching biocidal polyurethanes”, Biomaterials, 22: 2239, 2001. Al-Salah et al. used N-alkyl diethanol amine as chain extender to prepare a polyurethane, where quaternization was carried out by using polymeric quaternizers under strong agitation for at least 5 h at 60° C. followed by 10 h at room temperature. Al-Salah et al, “Polyurethane cationomers. I. structure-properties relationships”, J. Polym. Sci.: Part A: Polym. Chem., 26, 1609-1620 (1988). Quaternization with oxalic acid was carried out only at room temperature. The polymer solution was then cast into film and dried. All these methods comprised a complicated multi-step process including solution synthesis, quaternization, and rigorous purification to remove any residual alkyl halide and solvent. Additionally, these materials suffer from the loss of physical properties such as tensile strength and ultimate elongation due to hydration. Because the quaternary ammonium salts are attached as pendent groups in the hard segment, their mobility for reaching to the surface is limited and a higher concentration of these active chain-extender must be incorporated in order to be antimicrobial effective. Introducing quaternary amines to the soft-segment as side chains improved the surface activity of pendant quaternary ammonium salts, however, the bulk properties may also suffer from increased water absorbency and alternation of the microphase structure of the multiblock copolymers such as polyurethanes.

Therefore, a simple and cost effective method to create a biocidal surface on finished devices with long lasting biocidal efficacy is needed.

One advantage of, for instance, polyurethanes with built-in antimicrobial structures in polymer chains would be the molecular level homogeneity of the antimicrobial polymer system. The prior art teaches that inorganic antimicrobial agents such as silver and copper tend to discolor polymeric systems when used as coatings or when thermally forming products. See, for instance, US 2007/0021528 A1, entitled “Antimicrobial Acrylic Polymer.”

### SUMMARY OF THE INVENTION

In solving aforementioned problems and limitations, we have discovered novel and improved methods of creating antimicrobial surfaces comprised of polymers containing covalently bonded antimicrobial agents having the general formula L-R-S, wherein L is a linker capable of reacting to the monomer, oligomer, and polymers of various types, R is an antimicrobially active moiety, and S is an endgroup having high surface activity. These novel polymers present the antimicrobially active moieties at the contacting surface of the polymeric body. In an alternative embodiment, L is replaced by Q, a surface assembling moiety, and the group S is omitted.

In another aspect, the present invention provides a method of immobilizing and enhancing surface activity of the antimicrobial compounds incorporated into the polymer chain via endgroup attachment, without hampering the physical properties and processability of polymeric materials.

In another aspect, the present invention relates to the surface self-assembly of the attached antimicrobial compounds thereby providing an infection-resistant surface having superior antimicrobial properties. More specifically, the antimicrobial polymers of the invention may include attached antimicrobial compounds which bear a highly surface active and/or self-assembly composition wherein the surface active composition has high tendency of moving to surface during or after fabrication of the articles, thereby facilitating the migration of bioactive moieties to the surface to provide an infection-resistant surface having superior antimicrobial properties.

A further object of the present invention is to provide a method of accelerating the surface enrichment and/or assembly of the antimicrobial endgroups to provide an infection-resistant medical device having superior antimicrobial properties.

This invention also includes a method of creating a bioactive surface by an annealing treatment on articles in a specified condition, wherein said specified condition is a temperature that is 10° C. higher than the glass transition temperature and that is 30° C. below the melting temperature if crystalline or softening temperature, of the polymer used to fabricate the article. Alternatively, an antimicrobial surface may be formed in this invention by melting the polymer described herein having covalently bonded antimicrobial agents, shaping the polymer melt into an article, and quenching to solidify it.

Polymers produced as described above may be made into articles such as medical devices selected from the group consisting of urinary catheters, percutaneous catheters, central venous catheters, vascular access devices, peripheral lines, IV sites, drug delivery catheters, drains, gastric feeding tubes, trach tube, contact lens, orthopedic implant, neuro-stimulation lead, pace maker leads, blood bag, a wound care product, a personal protection device, birth control devices, packaging assembly. Such polymers may likewise be made into articles such as coatings for hospital equipment and marine ships that are in contacting with microorganism and that require the control of bacterial adhesion and bio-film formation.

### BRIEF DESCRIPTION OF THE DRAWINGS

The present invention will be more fully understood from the detailed description given hereinafter, and the accompanying drawings which are given by way of illustration only and thus do not limit the present invention.

FIG. 1 shows an ¹H NMR spectrum for C₁₂H₂₅N⁺(Me)₂(CH₂CH₂O)₂H a microbiocidally effective quaternary ammonium salt.

FIG. 2 shows an ¹H NMR spectrum and peak assignment for C₁₈H₃₇N⁺(Me)₂CH₂CH₂OH Cl⁻, a microbiocidally effective quaternary ammonium salt.

FIG. 3 shows an ¹H NMR spectrum for C₁₈H₃₇N⁺(Me)₂CH₂CH₂OH Br⁻, a microbiocidally effective quaternary ammonium salt.

FIG. 4 shows an ¹H NMR spectrum for the C₁₈H₃₇N⁺(Me)₂CH₂CH₂OH Cl⁻ quat, for a BIONATE® 80A polymer control, and for BIONATE® 80A polymer modified with said quat in accordance with the present invention, both before and after soxhlet extraction.

FIG. 5 shows a thermal gravimetric analysis in nitrogen and air of BIONATE® 80A polymer containing 0.5 weight-% of the antimicrobial quat C₁₈H₃₇N⁺(Me)₂CH₂CH₂OH Br⁻ in accordance with the present invention, along with a thermal gravimetric analysis of a BIONATE® 80A polymer control.

FIG. 6 shows a sum-frequency generation (SFG) analysis of tubing made from BIONATE® 80A polymer containing 0.5 weight % of the antimicrobial quat C₁₈H₃₇N⁺(Me)₂CH₂CH₂OH Br⁻ in accordance with the present invention along with a SFG analysis of BIONATE® 80A polymer control tubing.

FIG. 7 shows, via SFG analysis, the effect of annealing at 60° C. on films made of BIONATE® 80A polymer containing 0.5 weight-% of antimicrobial quat C₁₈H₃₇N⁺(Me)₂EtOH Cl⁻ in accordance with the present invention.

FIG. 8A depicts BIONATE® 80A polymer control tubing in a culture of Staphylococcus aureus. FIG. 8B depicts tubing made from BIONATE® 80A polymer containing 0.5 weight % of the antimicrobial quat C₁₈H₃₇N⁺(Me)₂CH₂CH₂OH Br⁻ in accordance with the present invention in a culture of Staphylococcus aureus.

### DETAILED DESCRIPTION OF THE INVENTION

It should be understood that the detailed description and specific examples which follow, while indicating particular embodiments of the invention, are given by way of illustration only, since various changes and modifications within the spirit and scope of the invention will become apparent to those skilled in the art as a result of this detailed description.

This invention involves a novel approach of providing a polymer having a surface with long lasting antimicrobial properties. In one embodiment of this invention, antimicrobial agents having the general formula of P-(L-R-S)ₙ are provided, wherein P represents a polymer backbone, L is an aliphatic or aromatic linker which covalently links the moiety R to the moiety P, R is an antimicrobially active moiety, and S is an endgroup having high surface activity. The moiety -(L-R-S) is thus an endgroup on the polymer molecule and the variable n is an integer of 1 to 2 in linear polymers and is an integer of 3 to 100 in branched or dendrite polymers.

Unlike methods based on the release of antimicrobial agent, the antimicrobial agents in the present invention are covalently bonded to the base polymer during or after the synthesis. Accordingly, they are much safer than materials which release, for instance, metal (e.g. silver) or chloride ions or other organic biocidal moieties.

### Certain Embodiments of the Invention

One embodiment of this invention is an antimicrobially active polymer molecule having the formula P-(L-R-S)ₙ wherein the moiety -(L-R-S)ₙ is an endgroup on said polymer molecule and the variable n is an integer of 1 to 2 in a linear polymer and is an integer of 3 to 100 in a branched or dendrite polymer. In the formula: P represents a polymer moiety having a number average molecular weight of 5000 to 1,000,000, and selected from the group consisting of polyurethanes, polysiloxanes, polyamides, polyimides, polyethers, polyesters, polycarbonates, polyolefins, polysulfones, and copolymers thereof; L represents an aliphatic or aromatic linkage having a number average molecular weight of up to about 1000, covalently linking the moiety R to the moiety P; R represents an antimicrobially active organic or organometallic moiety; and S represents a surface active endgroup having a number average molecular weight of up to 1000 and selected from the group consisting of straight, branched, or cyclic alkyl groups having 4 to 22 carbon atoms, polyalkylene oxides, fluorinated polyalkylene oxides, polysiloxanes, fluorinated polysiloxanes, polysiloxane polyethers, and mixtures thereof.

In accordance with this invention, the polymer molecule contains an amount of the moiety -(L-R-S)ₙ sufficient to impart antimicrobial properties to the molecule. Typically, from 0.1 weight-% to 20 weight-% or more of the polymer molecule will be contributed by the moiety -(L-R-S)ₙ. Generally, linear polymers will have a lower weight-% of that moiety, while a higher weight-% of branched or dendritic polymers may be attributable to the -(L-R-S)ₙ moiety therein. Often, the polymer molecule will contain from 0.1 to 10 weight-% of the moiety -(L-R-S)ₙ, or from 0.25 to 10 weight-% thereof. In accordance with this invention, the moiety -(L-R-S)ₙ moves to surface of an article made from a plurality of said polymer molecules during or after fabrication of the article, thereby providing a polymeric article in which the surface has antimicrobial properties.

In the antimicrobially active polymer molecule of this invention, R may be an antimicrobially active organic moiety selected from quaternary ammonium salts (e.g., halides), biguanides, phenols, alcohols, aldehydes, carboxylic acid esters, iodophores, parabens, imidazolidinyl ureas, azoniaadamantanes, isothiazolones, 2,3-imidazolidinediones, bronopols, fluoroquinolones, β-lactams, glycopeptides, aminoglycosides, and heparin.

In the antimicrobially active polymer molecule of this invention, P may be a thermoplastic polyurethane having a number average molecular weight of 5000 to 1,000,000, comprising about 5 to 75 wt % of at least one hard segment and about 95 to 25 wt % of at least one soft segment comprising at least one hydrophilic, hydrophobic, or amphipatic oligomer selected from aliphatic polyols, aliphatic and aromatic polyamines, and mixtures thereof.

In the antimicrobially active polymer molecule of this invention, the linkage L may comprises the residue of an aliphatic amine or aliphatic alcohol having from 2 to 30 carbon atoms. The linkage L may likewise comprise the residue of a silicone-containing alcohol or a silicone-containing amine having from 1 to 30 —Si(CH₃)₂O— repeat units.

The antimicrobially active polymer molecule of this invention may be a compound of the formula P-(L-R-S)ₙ wherein P is a thermoplastic polyurethane having a nominal number average molecular weight of 10,000 to 300,000, n is 2, and L-R-S has the formula —(OCH₂CH₂)_{y}N⁺[(CH₃)₂](CₓH₂ₓ₊₁) X⁻, wherein x is an integer from 6 to 22 (or from 8 to 18), y is an integer from 1 to 8 (or from 1 to 3), and X is a halogen (e.g., chlorine) atom. The antimicrobially active polymer molecules of this invention include compounds of the formula P-(L-R-S)₂ wherein P is a thermoplastic polyurethane having a nominal number average molecular weight of 10,000 to 300,000 and L-R-S is a moiety of the formula —(OCH₂CH₂)ₘN⁺[(CH₃)₂](CₓH₂ₓ₊₁) X⁻, wherein m is an integer of 1 to 3 and x is 8, 12, 16, or 18 and X is a chloride or bromide ion.

The antimicrobially active polymer molecule of this invention may be a compound of the formula P-(L-R-S)ₙ wherein P is a thermoplastic polyurethane having a nominal number average molecular weight of 10,000 to 300,000, n is 2, and L-R-S is a biguanide moiety of the formula

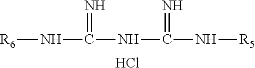

wherein R₆ is a group of the formula —O(CH₂)_{z}— in which z is an integer of from 1 to 18, covalently linking the biguanide moiety to the thermoplastic polyurethane, and R₅ is selected from the group consisting of straight or branched alkyl groups having 2 to 22 carbon atoms, aliphatic esters, aliphatic polyethers, fluorinated aliphatic polyethers, silicones, and silicone polyethers.

In another embodiment, this invention provides medical devices including urinary catheters, percutaneous catheters, central venous catheters, vascular access devices, intravenous delivery sites, drug delivery catheters, drains, gastric feeding tubes, tracheotomy tubes, contact lens, orthopedic implants, neuro-stimulation leads, pace maker leads, and blood bags. In accordance with the present invention, these devices are made from the antimicrobially active polymers described in the present application. This invention also contemplates coatings for hospital equipment or for marine ships, made from an antimicrobially active polymer of the invention. Likewise contemplated is an antimicrobially active polymer blend with a surface modifying antimicrobial polymer described herein as an additive.

This invention provides a method of imparting an antimicrobial surface to a medical device or a coating by conducting an annealing treatment on a medical device or on a coating at a temperature 10° C. higher than the glass transition temperature of the polymer of the invention used to fabricate the medical device or coating and 30° C. below the melting temperature or softening temperature of the polymer of the invention used to fabricate the medical device or coating. In another processing embodiment of this invention, a method of imparting an antimicrobial surface to a medical device or a coating is provided which comprises the steps of: melting a polymer according to the invention; shaping the polymer melt into an a medical device or a coating; and quenching the medical device or coating to solidify it into said medical device or coating have an antimicrobial surface.

### The Polymeric Backbone

P represents a polymer moiety having a number average molecular weight of 5000 to 1,000,000. Alternatively, the number average molecular weight of the polymer ranges from 10,000 to 500,000, or from 10,000 to 300,000. P may be selected from the group consisting of polyurethanes, polysiloxanes, polyamides, polyimides, polyethers, polyesters, polycarbonates, polyolefins, polysulfones, and copolymers thereof.

The polyurethanes usable as backbones in the present invention can be made by the reaction of polyisocyanates with polyols. Polyisocyanates for the preparation of a hard segment of the polyurethane backbone are aromatic or aliphatic diisocyanates, including alkyl diisocyanates, arylalkyl diisocyanates, cycloalkylalkyl diisocyanates, alkylaryl diisocyanates, cycloalkyl diisocyanates, aryl diisocyanates, cycloalkylaryl diisocyanates, all of which may be further substituted with oxygen, and mixtures thereof. Examples of suitable diisocyanates include hexamethylenediisocyanate, 4,4′-diphenylmethanediisocyanate, cyclohexane-1,4-diisocyanate, dicyclohexylmethanediisocyanate, 2,4-toluenediisocyanate, 2,6-toluenediisocyanate, hexamethylene-1,6-diisocyanate, tetramethylene-1,4-diisocyanate, naphthalene-1,5-diisocyanate, diphenylmethane-4,4′-diisocyanate, xylylenediisocyanate, dicyclohexylmethane-4,4′-diisocyanate, 1,4-benzene diisocyanate, 3,3′-dimethoxy-4,4′-diphenyldiisocyanate, m-phenylenediisocyanate, isophoronediisocyanate, polymethylenepolyphenyldiisocyanate, 4,4′-biphenylenediisocyanate, 4-isocyanatocyclohexyl-4′-isocyanate, and mixtures thereof. A subgenus thereof is constituted by diphenylmethanediisocyanate (MDI), dicyclohexylmethanediisocyanate, and mixtures thereof. The molecular weight of the diisocyanate component of the hard segment will typically be from 100-500 and often from 150-270. The chain extender of the hard segment used in the preparation of the copolymers of the invention may be an aliphatic polyol or an aliphatic or aromatic polyamine such as those known for preparing typically be from 18-500 and often from 60-200. A polyol component in the hard segment may be an alkylene, cycloalkylene, or arylene diol, triol, tetraalcohol, or pentaalcohol. Examples of polyols suitable for use in the preparation of the hard segment are 1,4-butanediol, ethylene glycol, 1,6-hexanediol, glycerine, trimethylolpropane, pentaerythritol, 1,4-cyclohexane dimethanol, and phenyldiethanolamine. A polyamine component in the hard segment may be an alkyl, cycloalkyl, or aryl amine which may be further substituted with nitrogen, oxygen, or halogen, complexes thereof with alkali metal salts, and mixtures thereof. Suitable polyamines for use in preparing the hard segment are p,p′-methylenedianiline and complexes thereof with alkali metal chlorides, bromides, iodides, nitrites, and nitrates, 4,4′-methylene-bis(2-chloroaniline), piperazine, 2-methylpiperazine, oxydianiline, hydrazine, ethylenediamine, cyclohexanediamine, xylylenediamine, bis(p-aminocyclohexyl)methane, the dimethyl ester of 4,4′-methylenedianthranilic acid, p-phenylenediamine, o-phenylenediamine, 4,4′-methylenebis(2-methoxyaniline), 4,4′-methylenebis(N-methylaniline), 2,4-toluenediamine, 2,6-toluenediamine, benzidine, dichlorobenzidine, 3,3′-dimethylbenzidine, 3,3′-dimethoxybenzidine, diansidine, 1,3-propanediol bis(p-aminobenzoate), and isophorone diamine. A soft segment of the polyurethane backbone may be a polyfunctional aliphatic polyol, or a polyfunctional aliphatic or aromatic amine, or a mixture thereof. The aliphatic polyol may be a linear or branched polyalkylene and polyalkenyl oxide, polycarbonate polyol, hydroxyl-terminated silicone, or a random or block copolymers thereof. Examples of polyols that are suitable for use in the present invention are polyethylene oxides, polypropyleneoxides, polytetramethylene oxide (PTMO), polypropylene oxide-polyethylene oxide copolymers, ethyleneoxide-terminated polyols, polytetramethylene oxide-polyethylene oxide copolymers, polycarbonate diols and triols, multifunctional hydroxyalkyl- or amine-terminated silicones, silicone-polyethyleneoxide copolymers, polybutadiene diols and triols, polyisobutylene diols and triols, polybutylene oxide diols and triols, and mixtures thereof. An amine component soft segment may be an amine-terminated homologues of the foregoing polyols. Examples of suitable amines are multifunctional amine-terminated polytetramethylene oxides, multifunctional amine terminated polyethylene oxides, multifunctional amine terminated polypropylene oxide-polyethylene oxide copolymers, multifunctional amine-terminated polytetramethylene oxide-polyethylene oxide copolymers, multifunctional amine-terminated silicones, amine-terminated silicon polyethylene oxide copolymers, and mixtures thereof.

The backbone polysiloxane moieties can be organopolysiloxanes having a viscosity varying from 10,000 to 500,000 centipoise at 25° C., wherein the organo groups are selected from monovalent hydrocarbon radicals and halogenated monovalent hydrocarbon radicals. Exemplary of such monovalent hydrocarbon radicals and halogenated monovalent hydrocarbon radicals are: alkyl radicals such as methyl, ethyl, and propyl; alkenyl radicals such as vinyl and allyl; cycloalkyl radicals such as cyclohexyl; monovalent aromatic radicals such as phenyl, and methylphenyl; halogenated monovalent aromatic radicals such as chlorophenyl; and halogenated alkyl radicals such as trifluoropropyl. Often, the organo radicals of such diorganopolysiloxane polymers are selected from alkyl radicals of 1 to 8 carbon atoms and from phenyl, chlorophenyl, tetrachlorophenyl, and trifluoropropyl radicals.

The polyamide homopolymers or copolymers making up the backbone in the present invention can be aliphatic polyamides or aliphatic/aromatic polyamides having a molecular weight of from about 10,000 to about 300,000. Such polyamides include the reaction products of diacids with diamines. Useful diacids for making polyamides include dicarboxylic acids which are represented by the general formula: HOOC—Z—COOH wherein Z is representative of a divalent aliphatic radical containing at least 2 carbon atoms, such as adipic acid, sebacic acid, octadecanedioic acid, pimelic acid, suberic acid, azelaic acid, dodecanedioic acid, and glutaric acid. The dicarboxylic acids may be aliphatic acids, or aromatic acids such as isophthalic acid and terephthalic acid. Suitable diamines for making polyamides include those having the formula: H₂N(CH₂)ₙNH₂ wherein n has an integer value of 1-16, and includes such compounds as trimethylenediamine, tetramethylenediamine, pentamethylenediamine, hexamethylenediamine, octamethylenediamine, decamethylenediamine, dodecamethylenediamine, hexadecamethylenediamine, aromatic diamines such as p-phenylenediamine, 4,4′-diaminodiphenyl ether, 4,4′-diaminodiphenyl sulphone, 4,4′-diaminodiphenylmethane, alkylated diamines such as 2,2-dimethylpentamethylenediamine, 2,2,4-trimethylhexamethylenediamine, and 2,4,4 trimethylpentamethylenediamine, as well as cycloaliphatic diamines, such as diaminodicyclohexylmethane, and other compounds. Other useful diamines include heptamethylenediamine, nonamethylenediamine, and the like. Useful polyamide homopolymers and copolymers include poly(4-aminobutyric acid), poly(6-aminohexanoic acid) (also known as poly(caprolactam)), poly(12-aminododecanoic acid), poly(hexamethylene adipamide), poly(hexamethylene azelamide), poly(tetramethylenediamine-co-oxalic acid), the polyamide of n-dodecanedioic acid and hexamethylenediamine, and the like. Useful aliphatic polyamide copolymers include caprolactam/hexamethylene adipamide copolymer, hexamethylene adipamide/caprolactam copolymer, and the like.

Polyimide backbone polymers may be made by condensing tetracarboxylic acid dianhydrides with aromatic or aliphatic diamines. Specific examples of tetracarboxylic dianhydrides which are contemplated include 3,3′,4,4′-benzophenonetetracarboxylic dianhydride, 3,3′,4,4′-biphenyltetracarboxylic dianhydride, 3,3′,4,4′-diphenylsulfonetetracarboxylic dianhydride, 4,4′-perfluoroisopropylidinediphthalic dianhydride, 4,4′-oxydiphthalic anhydride, bis(3,4-dicarboxyl) tetramethyldisiloxane dianhydride, bis(3,4-dicarboxylphenyl)dimethylsilane dianhydride, butane tetracarboxylic dianhydride, and 1,4,5,8-naphthalenetetracarboxylic dianhydride. Specific examples of diamines which are contemplated include m-phenylenediamine, p-phenylenediamine, 2,2′-bis(trifluoromethyl)-4,4′-diamino-1,1′-biphenyl, 3,4′-diaminodiphenyl ether, 4,4′-diaminodiphenyl ether, 3,3′-diaminodiphenyl ether, 2,4-tolylene-diamine, 3,3′-diaminodiphenyl sulfone, 3,4′-diaminodiphenyl sulfone, 4,4′-diaminodiphenyl sulfone, 3,3,′-diaminodiphenylmethane, 4,4′-diaminodiphenylmethane, 3,4′-diaminodiphenylmethane, 4,4′,-diaminodiphenyl ketone, 3,3′-diaminodiphenyl ketone, 3,4′-diaminodiphenyl ketone, 1,3-bis(4-aminophenoxy)benzene, 1,3-bis(3-amino-phenoxy)benzene, 1,4-bis(gamma-aminopropyl)tetramethyldisiloxane, and 4,4′-diaminodiphenyl sulfide.

The polyethers which may constitute backbone polymers in accordance with the present invention may be polyethylene oxides, polypropyleneoxides, polytetramethylene oxide (PTMO), polypropylene oxide-polyethylene oxide copolymers, and the like, having a molecular weight of from about 10,000 to about 300,000.

A polyester backbone polymer of this invention may be, for instance, a polycondensation product from a dicarboxylic acid and a diol. The diol may be selected from one or more diols including aliphatic diols such as ethylene glycol, trimethylene glycol, tetramethylene glycol, pentamethylene glycol, hexamethylene glycol, octamethylene glycol, decamethylene glycol, neopentyl glycol, diethylene glycol, polyethylene glycol and polytetramethylene ether glycol, alicyclic diols such as 1,2-cyclohexanediol, 1,4-cyclohexanediol, and 1,1-cyclohexanedimethylol, and aromatic diols such as xylylene glycol, 4,4′-dihydroxybiphenyl, 2,2-bis(4′-hydroxyphenyl)propane. The dicarboxylic acid may be selected from the diacids represented by the general formula HOOC—Z—COOH wherein Z is a divalent aliphatic radical containing at least 2 carbon atoms. Such dicarboxylic acids include adipic acid, sebacic acid, octadecanedioic acid, pimelic acid, suberic acid, azelaic acid, dodecanedioic acid, and glutaric acid. The dicarboxylic acids may be aliphatic acids, or aromatic acids such as isophthalic acid and terephthalic acid.

The polycarbonates usable as backbone polymers in the present invention may be prepared by reacting a dihydroxyaromatic compound such as: 2,2-bis-(4-hydroxyphenyl)propane—also known as bisphenol A; bis(4-hydroxyphenyl)methane; 2,2-bis(4-hydroxy-3-methylphenyl)propane; 4,4-bis(4-hydroxyphenyl)heptane; 2,2-(3,5,3′,5′-tetrachloro-4,4′-dihydroxyphenyl)propane; 2,2-(3,5,3′,5′-tetrabromo-4,4′-dihydroxyphenol)propane; 3,3′-dichloro-3,3′-dichloro-4,4′-dihydroxydiphenyl)methane; 2,2′-dihydroxyphenylsulfone; or 2,2′-dihydroxylphenylsulfide, or a dihydroxyaliphatic compound such as: 1,4-cyclohexanedimethanol; 1,2-propanediol; 1,3-propanediol; 1,4-butanediol; 1,6-hexanediol; 1,4-cyclohexanediol; 1,2-cyclohexanedimethanol; or 2,2,4,4-tetramethylcyclobutane-1,2-diol with a carbonate precursor such as phosgene, a haloformate, or a carbonate ester.

The polyolefins which may constitute backbone polymers in accordance with the present invention may be polyethylenes, polypropylenes, copolymers of ethylene and propylene, polybutenes, and the like, having a molecular weight of from about 10,000 to about 500,000.

The polysulfones which may constitute backbone polymers in accordance with the present invention have repeating units of the formula [—Ar—SO₂—] or [—Ar—SO₂—Ar—O—], in which Ar is a phenylene or naphthylene group which may be substituted with alkyl, haloalkyl, or halogen substituents.

### Linking the Antimicrobial Agent to the Polymeric Backbone

The antimicrobially effective endgroups “L-R-S” according to the present invention are introduced into polymers “P” by means of a reaction that results in the formation of a covalently bonding linkage “L” between the base polymer “P” and the antimicrobial moiety “R.” When the base polymer is a polyurethane or other isocyanate-derived polymer, terminal isocyanate groups can conveniently be reacted with appropriate precursors that contain the surface active moiety.

While such endgroup precursors are illustrated herein by alcohols and amines, any compound that contains an active hydrogen can be used to introduce the surface active moiety into the polymer. For instance, most compounds that contain a hydrogen atom bonded to oxygen react with isocyanate under proper conditions, including e.g. phenols. Essentially all compounds containing a hydrogen attached to a nitrogen are reactive, including e.g. amides. Sulfur compounds react in the same manner as their oxygen analogues, although at a much slower rate. Any method that results in the formation of covalent bonding between the microbially active moiety “R” and the base polymer “P” is thus contemplated according to the present invention.

The immobilization of antimicrobial agent is realized via the reaction of a reactive group in the linker attached to the antimicrobial agent. Such linkers include hydroxyl groups, amino groups, aldehydes, epoxides, anhydrides, isocyanates, carboxylic acids, Si—H groups, groups containing unsaturated functional moieties such as C═C, C≡C, and other reactive groups that can form covalent bonds with compositional components of polymers such as monomers, oligomers, crosslinkers, etc., commonly used in polymerization.

In accordance with the present invention, the surface activity of a polymer—resulting from the ability of the particularly configured polymers of the present invention to provide migration and enrichment of the bioactive moieties “R” at the surface of the polymer body which interfaces with its environment (air, body fluids and tissue, etc.)—is enhanced by introducing surface active endgroups tethered to the bioactive moieties. Such surface active endgroups are represented in the formula P-(L-R-S)ₙ by the variable “S.” Because the endgroups are attached to the polymer at one end, they are usually more mobile than the polymer backbone chains. This extra mobility allows the endgroups to diffuse through the bulk and concentrate at the polymer surface. Examples of surface active end-groups “S” are alkyl chains, fluorinated alkyl chains, polyether, fluorinated polyether, silicone, and other endgroups which result in a contact angle hysteresis on the surface of the polymer that is changed by at least 10% from the contact angle hysteresis of the surface of an otherwise identical polymer that does not contain the covalently bonded surface active endgroup.

Contact angle hysteresis is a well known method in which the so-called advancing contact angle of a liquid such as water is compared to its receding contact angle of the sessile droplet as it is retracted over the same surface. On a smooth surface the difference between advancing and receding angles, often expressed as a percent of the advancing angle, is a measure of contact angle hysteresis: the ability of the surface to minimize interfacial energy. A surface modifying endgroup that is capable of changing the contact angle hysteresis of the surface against the fluid of interest by greater than about 10% or more is significant. That degree of difference is sufficient to drive the SME to the surface, and for benefit to be derived from the presence of the SME in the surface of the modified polymer. A particularly useful case in certain applications occurs when the SME causes the liquid to exhibit an advancing angle on the modified surface that is greater than 90 degrees (nonwetting) and a receding contact angle of less than 90 degrees (wetting).

### The Antimicrobial Moiety

Persons skilled in the art are well aware of what is meant by the term “antimicrobial.” Moreover, persons skilled in the art are familiar with a wide variety of chemical substances that have antimicrobial properties. Nevertheless, Applicants provide a quantitative definition of the term “antimicrobial” in the context of the present invention. An antimicrobial endgroup moiety in the polymers of the present invention is a moiety which imparts to the polymer containing it the ability to reduce the concentration of E. coli at the surface of the polymer by a factor of 50% with reference to the effect of an otherwise similar polymer containing a diethylamino endgroup in place of the antimicrobial endgroup.

The antimicrobially active moieties R which afford the antimicrobial property to the polymers in accordance with this invention can be organic or organometalic compounds such as quarternary ammonium salts, phenols, alcohols, aldehydes, iodophores, poly quats (such as oligermeric poly quats derivatized from an ethylenically unsaturated diamine and an ethylenically unsaturated dihalo compound), biguanides, benzoates, parabens, sorbates, propionates, imidazolidinyl urea, 1-(3-chloroallyl)-3,5,7-triaza-1-azoniaadamantane chloride (Dowacil 200, Quaternium), isothiazolones, DMDM hydantoin (2,3-imidazolidinedione), phenoxyethanol, bronopol, fluoroquinolones (such as ciprofloxacin), “potent” β-lactams (third and fourth generation cephalosporins, carbapenems), β-lactam/β-lactamase inhibitors, glycopeptides, aminoglycosides, antibiotic drugs, heparin, phosphorylcholine compounds, sulfobetaine, carboxybetaine, and organometallic salts selected from silver salts, zinc salts, and copper salts and their derivatives. Examples of these antimicrobial agents includes pharmaceutical drugs such as penicillin, trichlosan, functional biguanides, mono-functional polyquaterniums, quaternized mono-functional polyvinylpyrrolidones (PVP), silane quaternary ammonium compounds, and other quaternized ammonium salts having the general formula:

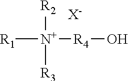

wherein (1) X is a pharmaceutically acceptable anion such as a sulphate anion, a phosphate anion, a carbonate anion, a halide anion, etc.; (2) R₁, R₂, R₃, R₄ are independently selected from the group consisting of straight or branched alkyl groups having 1 to 22 carbon atoms and substituted or unsubstituted phenyl or benzyl rings, aliphatic esters, aliphatic polyethers including fluorinated aliphatic polyethers, silicones, and silicone polyethers; (3) R₂ and R₃ may either be (a) taken together with N to form a saturated or unsaturated heterocyclic ring of from 5 to 7 atoms; (b) taken together with N, and combined with oxygen atom to form an N-morpholino group; or where (4) R₁, R₂, R₃ and N, taken together, represent quinoline, isoquinoline or hexamethylene tetramine. In a subgeneric embodiment, at least one of R₁, R₂, R₃ and R₄ is an alkyl group having 6-18 carbon atoms. In a more narrowly defined subgeneric embodiment, both R₄ and one of the R₁, R₂, and R₃ groups are aliphatic chains having at least 8 carbon atoms. Persons skilled in the art will recognize that alkyl groups having 6 or more carbon atoms will act herein as surface active endgroups “S” in the polymers of the formula P-(L-R-S)ₙ.

In a particularly useful embodiment, the antimicrobial moiety R is a quaternary ammonium molecule disclosed in U.S. Pat. No. 6,492,445 B2 (incorporated herein by reference).

Specific examples of suitable mono-functional antimicrobial compounds include 2-hydroxyethyldimethyldodecylammonium chloride, 2-hydroxyethyldimethyloctadecylammonium chloride, esterquats such as Behenoyl PG-trimonium chloride from Mason Chemical Company, Fluoroquats. Other small molecular diol bearing antimicrobial active centers can be incorporated into polyurethane backbone as chain extender. Examples of such antimicrobial chain extender includes: diester quats such as Methyl bis[ethyl(tallowate)]-2-hydroxyethyl]ammonium methylsulfate (CAS No. 91995-81-2), Ethoquads with general formula:

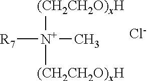

wherein, R₇ is an alkyl endgroup having ≧6 carbon atoms, X≧1. Specific examples of Ethoquads include: Octadecylmethylbis(2-hydroxyethyl)ammonium chloride (CAS No. 3010-24-0), Oleyl-bis-(2-hydroxyethyl)methylammonium chloride, Polyoxyethylene(15)cocoalkylmethylammonium chloride (CAS No. 61791-10-4) available from Lion Akzo Co. Ltd, and the like.

Examples of functional biguanides that may be suitable as antimicrobial surface-modifying endgroups include the hydroxyl functional structures of general formula:

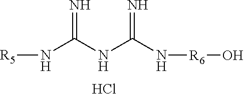

wherein R₅ and R₆ are independently selected from the group consisting of straight or branched alkyl groups having 2 to 22 carbon atoms and substituted or unsubstituted phenyl or benzyl rings, aliphatic esters, aliphatic polyethers, fluorinated aliphatic polyethers, silicones, or silicone polyethers.

### INDUSTRIAL APPLICABILITY

Combination of antimicrobial surface modifying endgroups “L-R-S” having different structures may be used to create synergistic effect on the biocidyl activity and broaden the spectrum of antimicrobial effect. By applying different types of antimicrobial endgroups such as quaternary amine, biguanide, and silver ions, the antimicrobial effectiveness and broadness can be optimized.

Yet in a particular useful aspect of the present invention, a method of accelerating surface enrichment and self-assembly of the antimicrobial endgroups is also disclosed. It has been discovered that the surface composition of the polymer can be affected by the method of fabrication of a useful article from the polymer. Annealing, and thermal forming methods such as injection molding or extrusion, accelerate the diffusion process and saturation rate of the surface with antimicrobial endgroups. The medical products with antimicrobial surfaces may be produced by coating with the polymers of the present invention.

Depending on the various aspects of coating process including solvent, solvent evaporation rate, method of applying the coating to the substrate (spray coating, dip coating, spin coating, roll-to-roll coating, web coating, etc), the surface thus produced may not have reached an equilibrium state, which is believed to be needed to yield optimum antimicrobial properties. According to the present invention, such a surface produced may be treated further by annealing to accelerate the migration of the antimicrobial agent to the surface for saturation. The term “annealing” as used herein, refers to the treatment of an article under conditions such that the maximum results can be achieved in a shortened time. In one embodiment of the present invention, the annealing is a treatment of the medical product at an elevated temperature with or without the presence of an aqueous or an organic solution environment. It is helpful if the solvent employed in the treatment is easily removed by means of an industrial drying process.

The invention further describes medical devices with antimicrobial agent saturated at the surface obtained directly from the thermal forming process. The term “thermal forming” as used herein, refers to the fabrication process that involves melting/plasticating the polymer and shaping into the product and component of finished form. Typical thermal forming processes include but are not limited to extrusion, injection molding, blow molding, compression molding, welding, and thermal bonding. The mobility of the antimicrobial agents attached to the polymer chain is increased with increasing temperature. The mobility of the polymer chain and attached endgroups experience a transitional increase when the polymer is melted, somewhat analogously to the solid to liquid phase transition of small molecules. By subjecting the polymer to a melting stage, the migration of antimicrobial agent to the surface is further accelerated, upon solidification a surface rich in antimicrobial agents can be directly produced without further treatment. The ordering of the surface layer is promoted in part by crystallization of the self assembling segments on the polymer surface.

### Examples

### Preparation of Hydroxyl Function Antimicrobial Quaternary Ammonium Halide

An exemplary quaternary ammonium halide (A) bearing hydroxyl functional group and multi-ethylene oxide (EtO) spacer can be prepared by the following reaction scheme

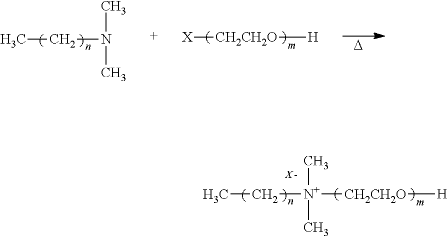

wherein, m=1-3, n=7, 11, 15, 17, and X is a chloride or bromide ion.

Preparation of 2-hydroxylethoxyethyldimethyldodecylammonium chloride, denoted as

C₁₂H₂₅N⁺(Me)₂(CH₂CH₂O)₂HCl⁻

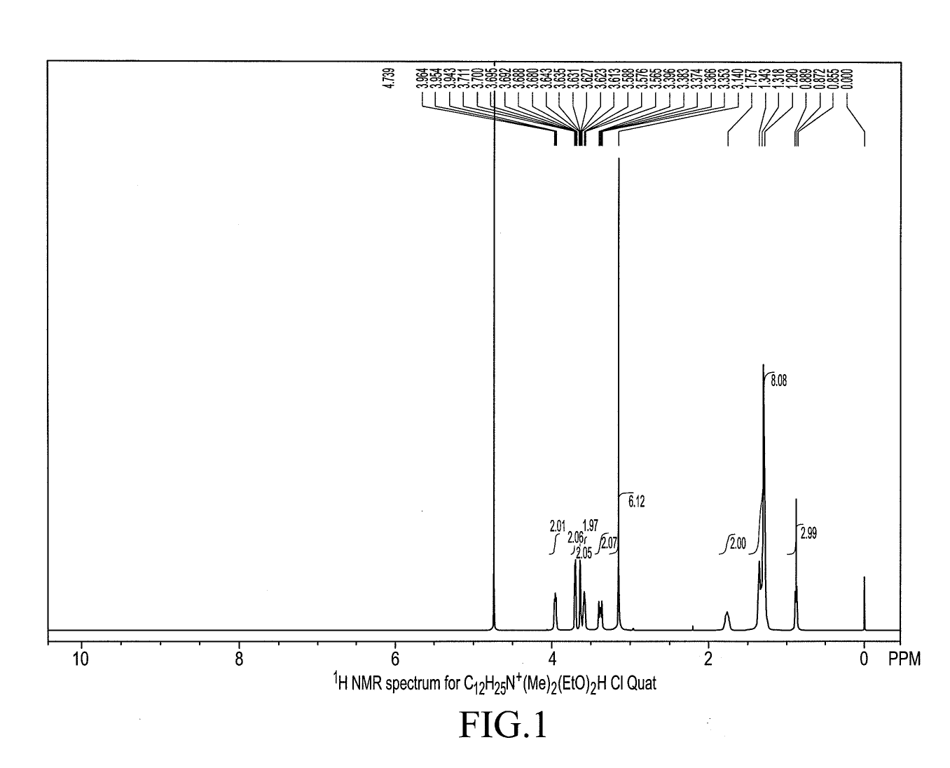

The antimicrobial quaternary ammonium chloride (A), where n=11, m=2, was prepared by mixing 85.36 grams of N,N-dimethyldodecylamine and 67.6 grams of deionized water in a 500 ml three neck round-bottomed flask equipped with an additional funnel, reflux condenser and a magnetic stirrer. The mixture was heated to 70° C. under nitrogen and 49.83 grams of 2-(2-chloroethoxy)ethanol was then added to the reaction mixture over 0.5 hrs. The reaction was heated to refluxing (˜100° C.) temperature and was kept for 14 hrs. A clear gel like mass was obtained after cooling to room temperature. The crude product was dried with a rotavap at 80° C., dissolved in warm acetone, and re-crystallized at about 3° C. The white crystalline powder obtained from this step was re-crystallized from warm acetone again to remove any impurity and starting materials. To remove residual water, the crystalline power was further re-crystallized from Acetone/THF (8/3, v/v) solvent mixture. The total yield was about 80%. FTIR and NMR characterization confirmed the structure and purity of ≧99%. See FIG. 1. Karl Fischer water titration indicated 0.12% of residual water, since the compound is used in small amounts (<2%) in the synthesis, the impact to overall water content is low enough for the typical polyurethane reaction.

Preparation of 2-hydroxylethoxyethyldimethyloctadecylammonium chloride, denoted as

C₁₈H₃₇N⁺(Me)₂CH₂CH₂OHCl⁻

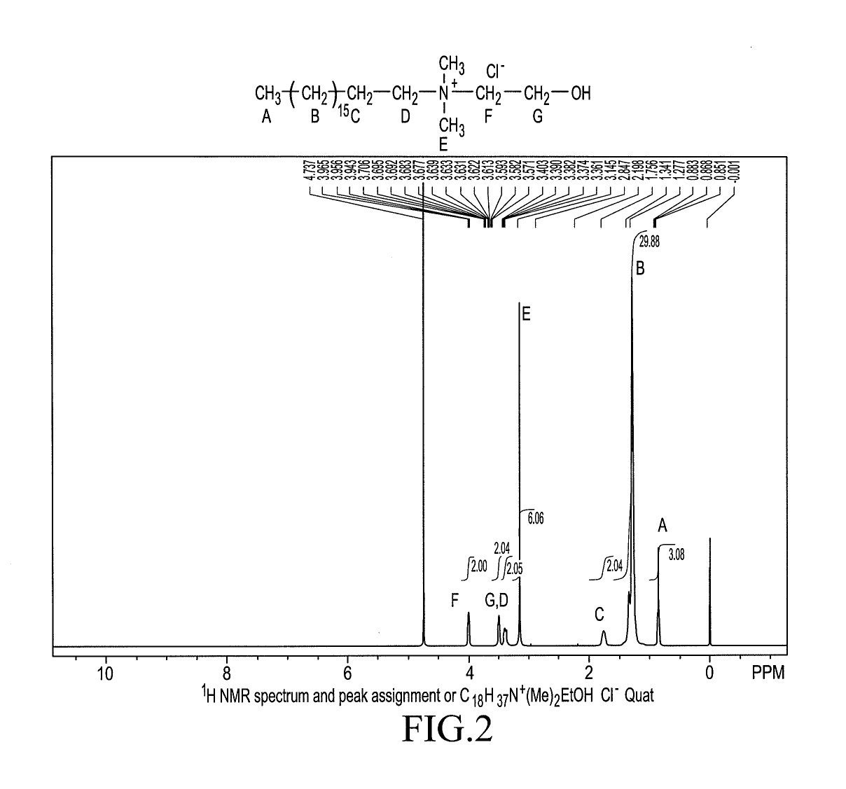

The quaternary ammonium chloride of (A), wherein x=18, m=1, was prepared by mixing 21.34 grams of N,N-Dimethylethanolamine and 43.34 grams of Octadecyl chloride in a 500 ml three-neck round-bottomed glass reactor and heating the mixture to 100° C. for 14 hrs. A white waxy solid was formed at the end of the reaction, and the crude product was purified by re-crystallization from acetone. About 20 grams of purified product in the form of thin flake was obtained. Karl Fischer water titration indicated 0.11% of residual water, since the compound is used at small amount (<2%), the impact to overall water content is low enough for the typical polyurethane reaction. FTIR and NMR characterization confirmed the structure and purity of ≧99%. See FIG. 2.

Preparation of 2-hydroxylethyldimethyloctadecylammonium bromide, denoted as

C₁₈H₃₇N⁺(Me)₂EtOHBr⁻

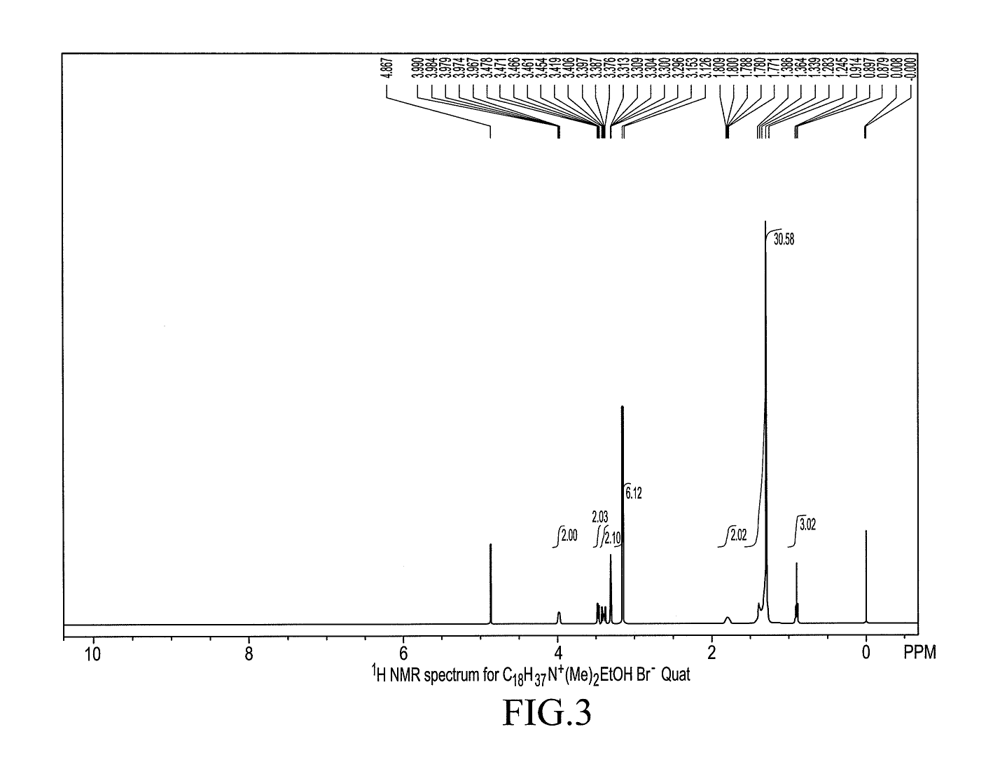

The quaternary ammonium bromide of (A), wherein x=18, m=1, was prepared by mixing 43.34 grams of N,N-Dimethyloctadecyllamine and 21.34 grams of 2-bromoethanol in a 500 ml three-neck round-bottomed glass reactor and heating the mixture to 100° C. for 14 hrs. A white waxy solid was formed at the end of the reaction, the crude product was purified by re-crystallization from acetone. About 20 grams of purified product in the form of thin flake was obtained. Karl Fischer water titration indicated 0.07% of residual water, since the compound is used at small amount (<2%), the impact to overall water content is low enough for the typical polyurethane reaction. FTIR and NMR characterization confirmed the structure and purity of ≧99%. See FIG. 3.

Other variations of quaternary ammonium halide (A) can be prepared similarly from the corresponding tertiary amine and alkyl halide.

### Generic Preparation of Mono-Hydroxyl Functional Biguanides

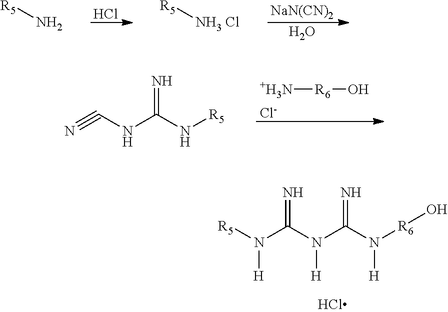

The synthesis of mono-hydroxyl functional biguanide can be carried out by reacting alkyl amine hydrochloride with sodium dicyanamide to afford alkyldicyandiamide, followed by reaction with mono-hydroxyl functional alkylamine hydrochloride. In the preceding structural formulas, R₆ is a group of the formula —O(CH₂)_{z}— in which z is an integer of from 1 to 18 and R₅ is selected from the group consisting of straight or branched alkyl groups having 2 to 22 carbon atoms, aliphatic esters, aliphatic polyethers, fluorinated aliphatic polyethers, silicones, and silicone polyethers. A specific example follows.

Preparation of N¹-2-hydroxylethyl phenyl-N⁵-octadecylbiguanide hydrochloride

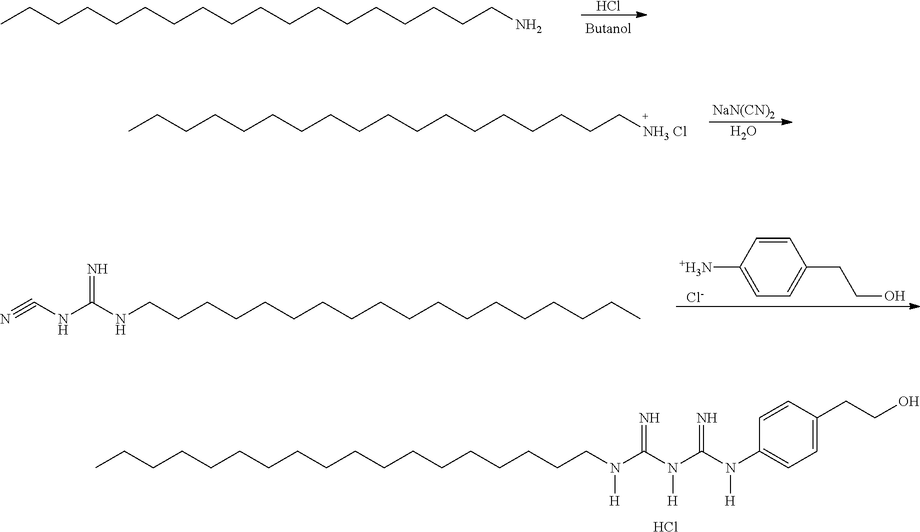

The synthesis of the intermediate octadecyldicyandiamide was carried out by first mixing 26.95 gram of octadecyl amine and 50 ml of 1N hydrochloric acid in 50 ml n-butanol at 60° C. A solution of 8.9 gram sodium dicyanamide in 20 ml de-ionized water was added to the reaction and reacted at 100° C. for 12 hrs. Upon cooling to room temperature (25° C.), the white solid was precipitated from the solution and was filtered through a fritted disk filter. The solid was re-crystallized from a mixture of water/IPA (4/1, v/v) and then from IPA, dried under vacuum to afford octadecyldicyandiamide in the form of white powder at 73% yield. The purity and structure was confirmed by NMR. Similarly, 2-hydroxylethylphenylamine hydrochloride was prepared from 4-(2-hydroxylethyl)aniline and 2N hydrochloric acid in isopropyl alcohol (IPA) and purified by re-crystallization from IPA and dried. The purity and structure was confirmed by NMR. The biguanide was then prepared from octadecyldicyandiamide and 2-hydroxylethylphenylamine hydrochloride in n-butanol. Thus, 1.68 grams of octadecyldicyandiamide and 0.87 gram of 2-hydroxylethylphenylamine hydrochloride were mixed in 8.5 grams of n-butanol. The mixture was heated to 115° C. to dissolve and react for 5 hrs. Upon cooling to room temperature, the crude solid was re-crystallized from IPA. The white solid was dried at 60° C. under vacuum overnight.

Preparation of Thermoplastic Polyurethane with Antimicrobial Agent Covalently Bonded to the Polymer Ends

An illustrative example of a thermoplastic polyurethane bearing antimicrobial activity is shown in the following formula, wherein PCU is polycarbonate urethane bulk chain.

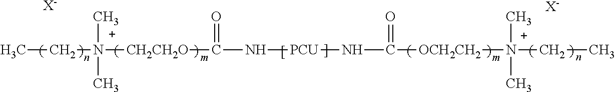

wherein, m=1-3, n=7, 11, 15, 17, and X is a chloride or bromide.

Thermoplastic polyurethanes with varying amount of antimicrobial agent covalently bonded to the polymer ends can be synthesized in either a batch reactor or by a continuous reactive extrusion process. As an example, in a two-step process, the prepolymer was first obtained by heating the mixture of MDI and polycarbonate diol (Mw=1727) at 60-100° C. for 2 hrs followed by the addition of a solution mixture of butane diol and hydroxyl functional quaternary ammonium halide. The molten mixture was stirred rigorously for 5-10 minutes before transfer to a clean PE container and was post-cured at 100° C. for 24 hrs. The hardened polymer slab was then grinded into smaller granules for solution preparation or re-pelletization. A control sample without antimicrobial agent was obtained from commercially available BIONATE® 80A, a polycarbonate urethane block copolymer having an aromatic urethane hard segment and a polycarbonate soft segment, produced by DSM PTG of Berkeley, Calif.

An illustrative example of a thermoplastic polyurethane bearing antimicrobial biguanide endgroups is described in the following formula, wherein PCU is polycarbonate urethane bulk chain.

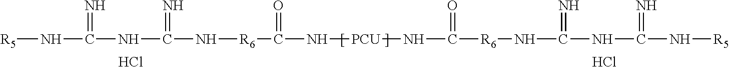

Thus, the prepolymer was first obtained by heating the mixture of MDI and polycarbonate diol (Mw=1992) at 55-100° C. for 2.5 hrs followed by the addition of a solution mixture of butane diol and biguanide hydrochloride. The molten mixture was stirred rigorously for 5-10 minutes before transfer to a clean container and was post-cured at 80-100° C. for 24 hrs. The hardened polymer slab was then grinded into smaller granules for solution preparation or re-pelletization.

### Film Sample Preparation

Polymer solutions of 15-20% solid content were prepared by dissolving polymer pellets in dimethylacetamide (DMAc) solvent followed by filtration using 20 micron stainless steel filter. The filtered solutions were then cast into 0.002-0.004 inch thick films on polyethylene terephalate (PET) Mylar substrate and dried at 50° C. using a continuous web coater. The film samples were then soaked in the de-ionized water at room temperature overnight and air dried. Residue solvent in the films was analyzed using a headspace gas chromatography and was found below detectable level (ca. 10 ppm). These film samples were later used for antimicrobial testing, sum-frequency generation spectroscopy (SFG) analysis, and co-efficient of friction (COF) testing.

### Physical Properties

The impact of incorporating antimicrobial surface modifier on physical properties such as molecular weight, mechanical properties, contact angle, water absorption, and co-efficient of friction were investigated and compared with the standard BIONATE® 80A control. The polymer retained good strength and high elasticity typical to the thermoplastic polyurethane elastomer (TPU). No noticeable increase of water uptake was found after soaking in water for 24 hrs at room temperature in comparison with the control. The results are summarized in Table 1, which shows molecular weight, mechanical properties, and water uptake for the BIONATE® 80A control and BIONATE® 80A polymers containing antimicrobially active endgroups in accordance with the present invention.

TABLE 1

| Antimicrobial quat | Quat | Mw | Ult. Tensile | Ult. Elong. | 50% Sec. Mod. | Water uptake |
|---|---|---|---|---|---|---|
| starting materials | Wt % | (Dalton) | (psi) | (%) | (psi) | % |
| Control | 0 | 216891 | 7267 | 504 | 1423 | 0.71 |
| (contains no quat) | | | | | | |
| C₁₈H₃₇N⁺(Me)₂EtOH Cl⁻ | 0.5 | 191415 | 6132 | 525 | 1506 | 0.74 |
| C₁₈H₃₇N⁺(Me)₂(EtO)₃H Cl⁻ | 1.0 | 254663 | 6706 | 509 | 1519 | 0.40 |
| C₁₈H₃₇N⁺(Me)₂EtOH Br⁻ | 0.5 | 172785 | 6543 | 575 | 1570 | 0.60 |
| C₁₂H₂₅N⁺(Me)₂(EtO)₂H Cl⁻ | 0.5 | 283006 | 7294 | 535 | 1461 | 0.79 |
| C₁₂H₂₅N⁺(Me)₂(EtO)₂H Cl⁻ | 1.0 | 162032 | 5890 | 534 | 1526 | 0.84 |

Using a contact angle goniometer, the contact angles were measured on the cast film samples and reported on the average of 5-10 measurements. Table 2 shows contact angle and co-efficient of friction for a BIONATE® 80A control and BIONATE® 80A polymer modified with antimicrobially active endgroups in accordance with the present invention.

TABLE 2

| Antimicrobial quat | | Contact | Static | Kinetic |
|---|---|---|---|---|
| starting materials | Quat Wt % | angle (°) | COF | COF |
| BIONATE ® 80A control | 0 | 69 | 8.24 | 3.15 |
| C₈H₁₇N⁺(Me)₂EtOH Cl⁻ | 0.5 | 70 | 4.11 | 2.03 |
| C₁₈H₃₇N⁺(Me)₂EtOH Br⁻ | 0.5 | 67 | 3.83 | 1.99 |
| C₁₈H₃₇N⁺(Me)₂EtOH Br⁻ | 1 | 70 | 4.21 | 2.16 |
| C₁₈H₃₇N⁺(Me)₂(EtO)₃H Cl⁻ | 1 | 68 | 2.67 | 1.91 |

From the results tabulated in Table 2, it appears that the wettability of water on the quats-modified BIONATE® and on the control is about the same, whereas the co-efficient of friction measured on the polyethylene substrate per ASTM D1894 is lower for the quats-modified BIONATE® compared with the control. The reduced COF is a desirable feature for many medical applications, such as improved handling property (non-sticky), reduced surface wear for a moving part, and tissue interference related to the insertion of the medical device.

### Non-Leaching Behavior and Thermal Stability

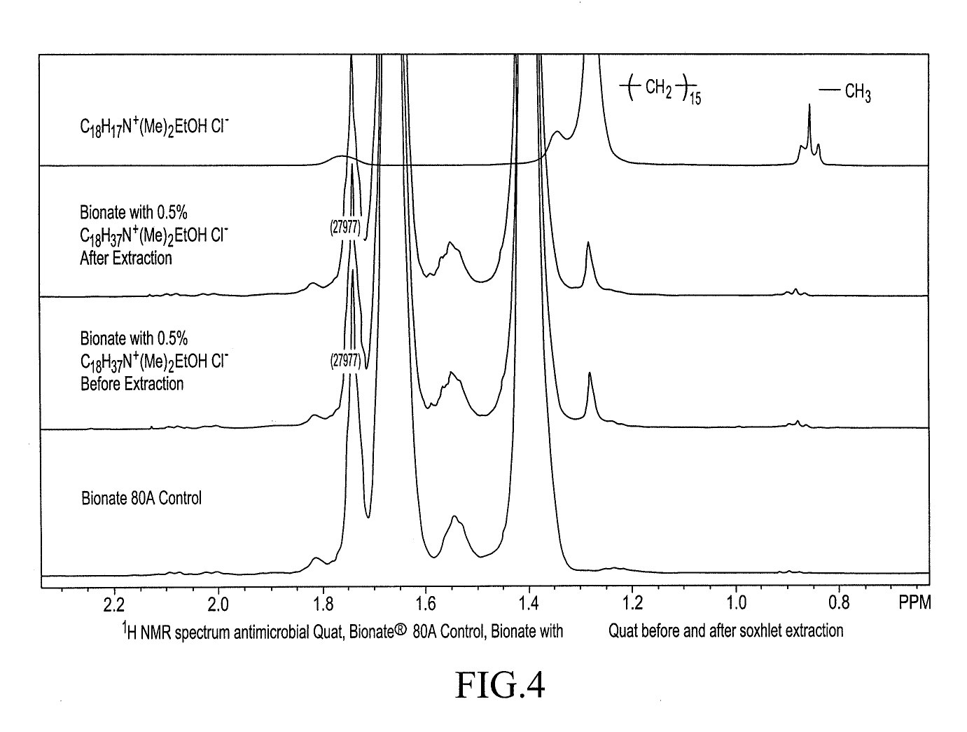

Film samples were subjected to 16 hrs soxhlet extraction using de-ionized water as the solvent to study the non-leaching stability of antimicrobial surface modifier bonded to the polymer ends. If the antimicrobial quats are not chemically bonded or if the bonds are susceptible to the boiling water, the quats will be dissolved in water extracted from the polymer. After the extraction, the film samples were analyzed by NMR. As indicated in FIG. 4, Proton peaks associated with the terminal methyl and adjacent methylene groups of the quaternary ammonium salt were still present and remained quantitatively equivalent after rigorous soxhlet extraction. This provides evidence that the antimicrobial agents were covalently bonded to the polymer and stable in hot aqueous environment.

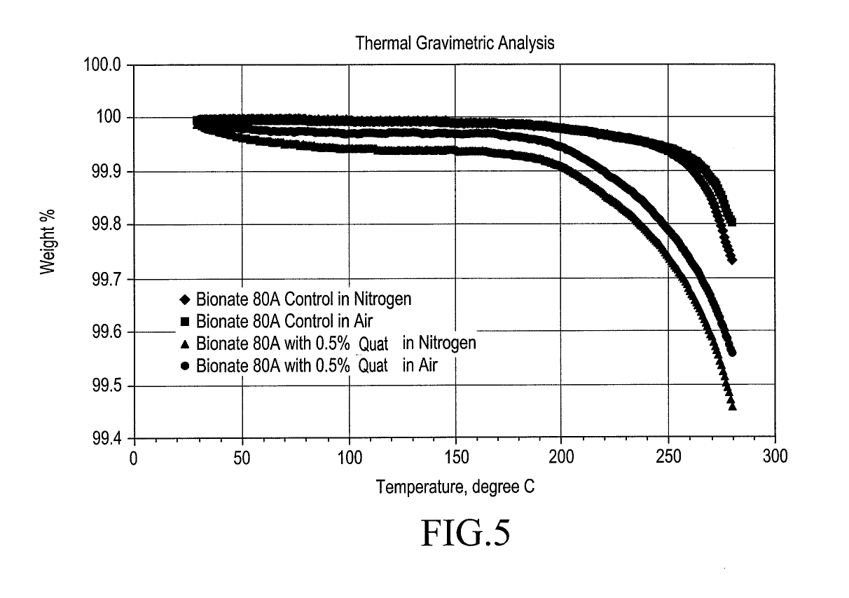

Thermal stability is critical for the medical plastics to be processed via conventional thermal forming process such as extrusion and molding. Any significant thermal degradation (>0.2%) may cause severe out-gassing and lead to rough surface and inferior physical properties of the product. For typical BIONATE® products, a thermal processing window of 160-200° C. is recommended for extrusion and injection molding barrel temperature. As can be seen from FIG. 5, the BIONATE® 80A pellet containing quaternary ammonium endgroups exhibited good thermal stability, with less than 0.1% weight loss up to the 200° C. The materials thus prepared are therefore suitable for the standard thermal forming processing.

The non-leaching property was also studied by antimicrobial leaching experiments. These tests are to determine if any toxic compounds leach from the various materials. Polymer samples are submerged in sterile growth medium and allowed to incubate for 24-hrs under sterile conditions. The medium is then inoculated with either Staphylococcus epidermidis or Pseudomonas aeruginosa and the numbers of suspended live and dead bacterial cells quantified with elapsed time. Essentially there was no effect of any material sample on the suspended growth of Staphylococcus epidermidis or Pseudomonas aeruginosa (similar results to S. epidermidis obtained). In conclusion, nothing toxic leached from the material over a 24 hr period; any inhibition of bacterial attachment would thus be due to some effect other than killing suspended cells.

### Tubing Extrusion

Pellets of BIONATE® 80A with 0.5 wt % of antimicrobial quaternary ammonium salt, C₁₈H₃₇N⁺(Me)₂EtOH Br⁻, covalently bonded to the polymer ends were dried in a two-bed regenerative dessicant dryer at 170° F. overnight. Tubing of 0.072″ ID and 0.082″ OD was then extruded from a precision tubing extrusion line comprised of 1″ single screw extruder with L/D=25/1 barrel, a cross-head die, lumen air controller, DI water cooling tank, puller and cutter and other online measurement accessories including ultrasound wall measurement, 2-head laser OD measurement. The tubing was quenched in a DI water tank and cut to the length (20″). 1.5″ long section was then directly used for the Zone of inhibition test. Film samples were also collected by blowing the tubing into balloon and later cut into square films for antimicrobial testing. It was found that the tubing made from quat-modified BIONATE® 80A has much less tendency to stick each other compared to the BIONATE® 80A control tubing of exact same size. This is better understood with the help of tubing surface analysis by Sum Frequency Generation Spectroscopy (SFG).

WO 2007/142683 A2, entitled SELF-ASSEMBLING MONOMERS AND OLIGOMERS AS SURFACE-MODIFYING ENDGROUPS FOR POLYMERS, describes a surface-specific analytical technique with monolayer sensitivity which has been successfully applied to various kinds of surfaces and interfaces. See paragraphs [0058]-[0062] therein. Through IR and visible (laser light) sum-frequency generation spectroscopy (SFG), a powerful and versatile in situ surface probe has been created that not only permits identification of surface molecular species, but also provides information about orientation of functional groups at the surface. It is nondestructive, highly sensitive, and has good spatial, temporal, and spectral resolution. Because SFG is surface specific, the technique can be used to probe any interfaces as long as the media through which the laser light passes does not interfere with the laser light. Examples of the interface accessible by SFG include, but are not limited to, the polymer/gas interface and polymer/liquid interface.

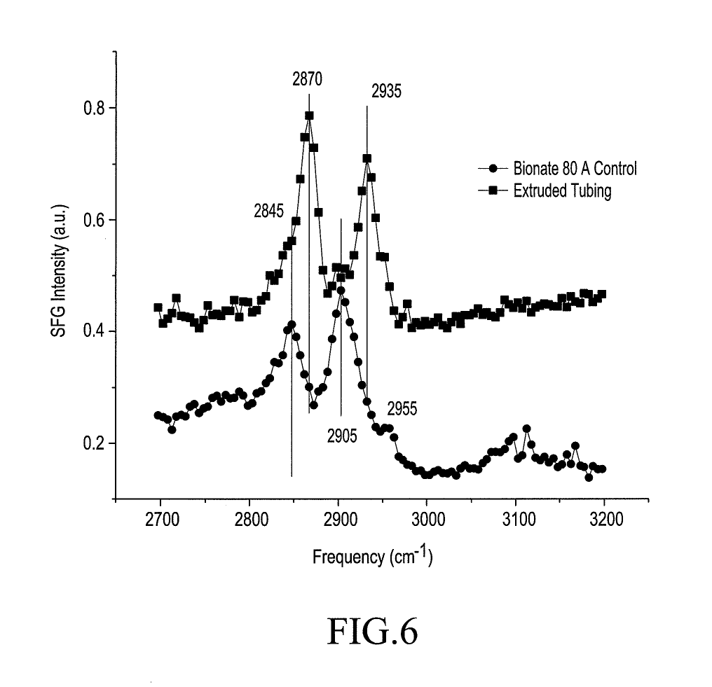

As can be seen in FIG. 6, the dominant features observed on the SFG spectrum of control tubing are two main peaks at 2845 cm⁻¹ and 2905 cm⁻¹ associated to the symmetric and asymmetric stretch of methylene group from polycarbonate soft-segment, respectively. In comparison, the quat modified polymer tubing surface was featured with two peaks at 2870 cm⁻¹ and 2935 cm⁻¹ associated to the symmetric and Fermi resonance of terminal methyl group. Because the terminal methyl group only takes about 0.02 wt % of the polymer weight, the complete coverage of methyl group deduced from the SFG results indicates that the octadecyl endgroups are well ordered and assembled at the surface with terminal methyl groups covering the outmost layer. The octadecyl layer assembled on surface may act like a lubricant thereby reducing the surface stickiness.

### Annealing Effect on the Surface

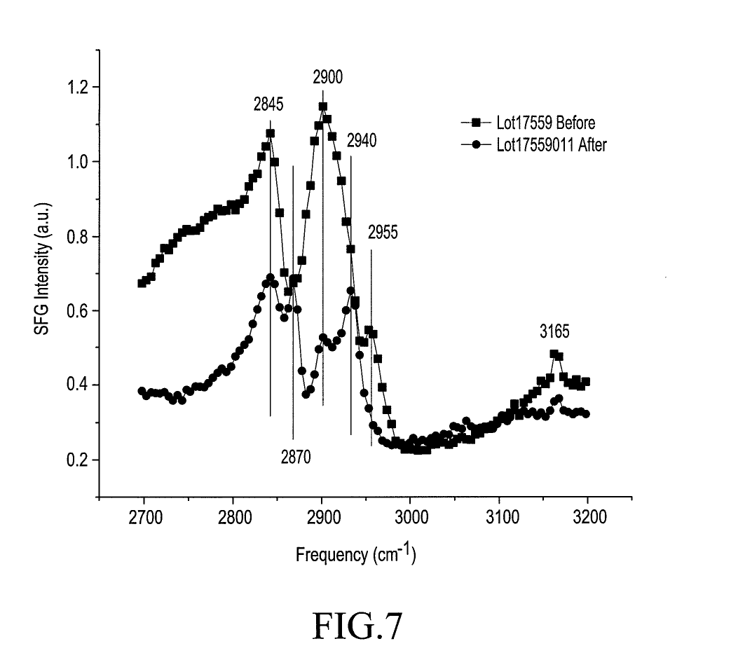

The migration of quat endgroups to the surface of formed articles largely depends on the temperature and physical state of the polymer. While melted the polymer chains are more mobile and gain more free volume, allowing the endgroups to move to the surface and reach equilibrium in a short time. As a result the tubing extruded from melt state features saturated and well order alkyl endgroup. The solution cast films showed less surface feature with dominant peaks at 2845 cm⁻¹ and 2905 cm⁻¹ associated with the symmetric and asymmetric stretch of methylene groups. See FIG. 7. Upon annealing at 60° C. overnight, the terminal methyls emerged as suggested from the increase of peaks associated with symmetric stretch and Fermi resonance of methyl group. During the film forming process, the hydrophilic DMAc vapor phase may create a blanket immediately above the polymer surface, due to the hydrophilic and hydrophobic interaction, the hydrophobic octadecyl endgroups were suppressed from emerging to the surface and were “entrapped” when the filmed was dried. The “entrapped” endgroups require little energy and were able to migrate to the surface in a short time upon annealing at an elevated temperature. This would provide a method to access the underlying bioactive groups and maximize the biological performance such as antimicrobial property.

### Antimicrobial Properties

The antimicrobial efficacy was tested on film samples described above. Staphylococcus aureus (ATCC 6538) and Pseudomonas aeruginosa (ATCC15442) strains were used as the Gram positive and Gram negative test species, respectively. ASTM E2180 “Method for Determining Antimicrobial Activity in Polymer or Hydrophobic Materials” was used as the test protocol. This standard test involves an agar slurry inoculum vehicle that provides a relatively uniform contact of the inocula with antimicrobial treated hydrophobic surfaces. The method can confirm the presence of antimicrobial activity in plastics or hydrophobic surfaces and allows determination of quantitative differences in antimicrobial activity between untreated plastics or polymers and those with bound or incorporated low water-soluble antimicrobial agents. Listed in Table 3 are the cell reduction results after 24 hrs exposure on a 2 cm×2 cm film surface.

TABLE 3

| | | 24 Hour % | |
|---|---|---|---|
| | | Cell Reduction | |
| Quat starting materials | % Quat | Relative to Control | |
| incorporated into | in | Staphylococcus | Pseudomonas |
| BIONATE ® 80A | Polymer | aureus (+) | aeruginosa (−) |
| C₈H₁₇N⁺(Me)₂EtOH Cl⁻ | 0.5 | 99.8 | 10.2 |
| C₁₈H₃₇N⁺(Me)₂EtOH Cl⁻ | 0.5 | 99.8 | 0 |
| C₁₈H₃₇N⁺(Me)₂(EtO)₃H Cl⁻ | 0.5 | >99.9999 | 8.7 |
| C₁₈H₃₇N⁺(Me)₂(EtO)₃H Cl⁻ | 1.0 | >99.9999 | 20.7 |
| C₁₈H₃₇N⁺(Me)₂EtOH Br⁻ | 0.5 | >99.9999 | 8.7 |
| C₁₈H₃₇N⁺(Me)₂EtOH Br⁻ | 1.0 | >99.9999 | 24.0 |

While the control. BIONATE® 80A films did not cause any cell reduction, the quats modified polymer films showed very effective biocidal effect on the gram positive Staphylococcus aureus and some effect on the Pseudomonas aeruginosa.

The antimicrobial property of the polymer film containing 1% of Quat C₁₈H₃₇N⁺(Me)₂(EtO)₃H Cl⁻ was also tested against Methicillin Resistant Staphylococcus aureus—MRSA (ATCC 33592), a 4 log reduction of colony forming units (CFU) was observed, suggesting that the polymer surface is also effective against MRSA strain.

An enhanced antimicrobial effect on Pseudomonas aeruginosa was observed on the extruded films (Table 4), presumably due to the further enrichment of quat endgroups at the surface during extrusion.

TABLE 4

| | | 24 Hour % | |
|---|---|---|---|
| | | Cell Reduction | |
| Quat starting material | % Quat | Relative to Control | |
| incorporated into | in | Staphylococcus | Pseudomonas |
| BIONATE ® 80A | Polymer | aureus (+) | aeruginosa (−) |
| C₁₈H₃₇N⁺(Me)₂(EtO)₃H Cl⁻ | | >99.999 | 94.7 |

### Zone of Inhibition

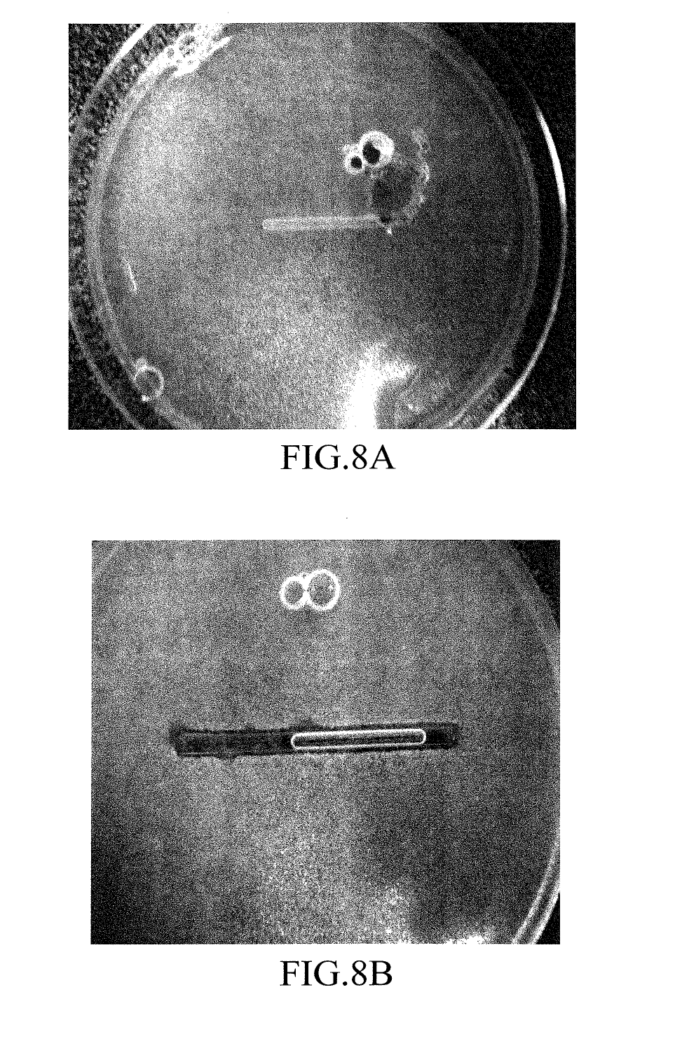

The abilities of the tubing samples made from quats modified polycarbonate urethanes to resist bacterial growth and possibility of biocidal leaching out to the contacting environment were examined through zone of inhibition experiment. Results are shown in FIG. 8A and FIG. 8B. The tubing made from quat-modified BIONATE® 80A in accordance with the present invention, exhibited a contact inhibition on Staphylococcus aureus (ATCC 6538) characterized by zones of inhibition with dimension in approximate to the projected area of tubing (0.174″×1.50″). See FIG. 8A. The tubing remained clear, transparent and appeared to be free of bacterial adhesion. No zone of inhibition typical of leaching biocide was developed beyond the immediate surface area of the tubing. In contrast, no contact inhibition was observed on the control tubing which turned into opaque object with surface fully covered by bacterial colonies. See FIG. 8B. Together, the results depicted in FIG. 8A and FIG. 8B demonstrate that articles made in accordance with the present invention have useful antimicrobial properties.

### Manufacture of Formed Articles

Unconfigured L-R-S-containing polymers in accordance with the present invention may be converted to formed articles by methods used to process the unmodified base polymers. Such methods include melt processing methods (e.g., extrusion), injection molding, compression molding, calendaring, and intensive mixing. The polymers may also be processed by solution-based techniques such as spraying, dipping, casting, and coating. Evaporation of a volatile liquid (e.g. organic solvent or water) leaves behind a film of the SME polymer.

Polymeric articles made from the compositions of this invention will often have: a tensile strength of from about 350 to about 10,000 psi, elongation at break from about 300 to about 1500%, an unsupported thickness of from about 5 to about 100 microns, and a supported thickness of from about 1 to about 100 microns.

Polymers according to the present invention can be used to make articles such as cardiac-assist devices, e.g. artificial hearts and intro-aortic balloons; catheters and catheter-introducers; pacemaker leads; vascular grafts; prosthetic implants, such as heart valves, ligaments, tendons, and joint replacements; condoms and condom coatings; and gloves and glove coatings. This invention also provides biocompatible films formed from the polymer of the invention, which films may be coated onto a support. The film of the invention is provided in the form of a flexible sheet and a hollow membrane or fiber. Typically, the flexible sheet may be prepared as a long rollable sheet of about 10 to 15 inches width and 1 to 6 feet length. However, as persons skilled in the art will appreciate, other dimensions may also be selected.

The flexible sheet is prepared from the block copolymer of the invention by methods known in the art, typically, by casting, and more preferably by casting on a web or release liner. The composition may be coated as a film onto a substrate. Where permanently supported on a reinforcing web, e.g., a fabric, the film or membrane may be thinner, e.g., as thin as about 1 micron, whereas when used unsupported the thickness may only be as low as about 5 to 10 microns. When membranes are fabricated from the polymer of the invention by knife-over-roll casting onto a release paper, web, or liner in the form of dry films, they may have an about 1 to 100 micron nominal thicknesses on a continuous coating line.

The membrane of this invention may have any shape resulting from a process utilizing a liquid which is subsequently converted to a solid during or after fabrication, e.g., solutions, dispersions, 100% solids prepolymer liquids, polymer melts, etc. Converted shapes may also be further modified using methods such as die cutting, heat sealing, solvent or adhesive bonding or any of a variety of other commonly-used fabrication methods. For example, when in the form of a hollow tube intended for use, e.g., as a catheter, the membrane is generally prepared with an outside diameter of about 0.5 to 10 mm, and more preferably about 1 to 3 mm, and a thickness of about 1 to 100 microns, and more preferably about 19 to 25 microns. A specific examples of a catheter is a hollow tube made from a membrane having a thickness of 24 microns and an outside diameter of 2.7 mm made from BIONATE® 80A polymer containing 1 weight-% of endgroups made from the antimicrobially active quat C₁₂H₂₅N⁺(Me)₂(EtO)₂H Cl⁻.

The fabrication methods just described employ liquid solutions or reactive liquid prepolymers of the membrane polymers. In the case of linear polymers of the present invention, thermoplastic fabrication methods may also be employed. Membrane polymers made by the bulk or solvent-free polymerization method described above may be cast into, e.g., a teflon-lined pan during the polymerization reaction. As the reaction proceeds and the polymerizing liquid becomes a rubbery solid, the pan may be postcured in an oven at, e.g., 100-120° C. for about 1 hour. Upon cooling, the rubbery mass may be chopped into pellets and dried in a dehumidifying hopper dryer for, e.g., about 16 hours. The dry pellets may then be compression molded, e.g., at about 175° C. to form a flat membrane which, when cool, will leave a thickness of about 0.5 mm. Extrusion, injection molding, calendaring and other conversion methods that are well-known in the art may also be used to form membranes, films and coatings of the polymers of the present invention, including solid fibers, tubing, medical devices and prostheses, and so on.

The invention being thus described, it will be manifest to persons skilled in the art that the same may be varied in many ways. Such variations are not to be regarded as a departure from the spirit and scope of the invention, and all such modifications as would be obvious to one skilled in the art are intended to be included within the scope of the following claims.

1. An antimicrobially active polymer molecule having the formula P-(L-R-S)ₙ wherein the moiety -(L-R-S)ₙ is an endgroup on said polymer molecule and the variable n is an integer of 1 to 2 in a linear polymer and is an integer of 3 to 100 in a branched or dendrite polymer, in which:
P represents a polymer moiety having a number average molecular weight of 5000 to 1,000,000, and selected from the group consisting of polyurethanes, polysiloxanes, polyamides, polyimides, polyethers, polyesters, polycarbonates, polyolefins, polysulfones, and copolymers thereof;
L represents an aliphatic or aromatic linkage having a number average molecular weight of up to about 1000, covalently linking the moiety R to the moiety P;
R represents an antimicrobially active organic or organometallic moiety; and
S represents a surface active endgroup having a number average molecular weight of up to 1000 and selected from the group consisting of straight, branched, or cyclic alkyl groups having 4 to 22 carbon atoms, polyalkylene oxides, fluorinated polyalkylene oxides, polysiloxanes, fluorinated polysiloxanes, polysiloxane polyethers, and mixtures thereof,
wherein the moiety -(L-R-S)ₙ moves to surface of an article made from a plurality of said polymer molecules during or after fabrication of the article, thereby providing a polymeric article in which the surface has antimicrobial properties.

2. The antimicrobially active polymer molecule of claim 1, wherein R is an antimicrobially active organic moiety selected from the group consisting of quaternary ammonium salts, biguanides, phenols, alcohols, aldehydes, carboxylic acid esters, iodophores, parabens, imidazolidinyl ureas, azoniaadamantanes, isothiazolones, 2,3-imidazolidinediones, bronopols, fluoroquinolones, β-lactams, glycopeptides, aminoglycosides, and heparin.

3. The antimicrobially active polymer molecule of claim 2, wherein R is a quaternary ammonium halide.

4. The antimicrobially active polymer molecule of claim 2, wherein R is a biguanide.

5. The antimicrobially active polymer molecule of claim 1, wherein P is a thermoplastic polyurethane having a number average molecular weight of 5000 to 1,000,000, comprising 5 to 75 wt % of at least one hard segment and 95 to 25 wt % of at least one soft segment comprising at least one hydrophilic, hydrophobic, or amphipatic oligomer selected from the group consisting of aliphatic polyols, aliphatic and aromatic polyamines, amine or hydroxyl terminated silicone fluids, and mixtures thereof.

6. The antimicrobially active polymer molecule of claim 1, wherein the linkage L comprises the residue of an aliphatic amine or aliphatic alcohol having from 2 to 30 carbon atoms.

7. The antimicrobially active polymer molecule of claim 1, wherein the linkage L comprises the residue of a silicone-containing alcohol or a silicone-containing amine having from 1 to 30 —Si(CH₃)₂O— repeat units.

8. The antimicrobially active polymer molecule of claim 1, wherein S is a straight, branched, or cyclic alkyl group having from 4 to 22 carbon atoms.

9. The antimicrobially active polymer molecule of claim 1, selected from the group consisting of compounds of the formula P-(L-R-S)ₙ wherein P is a thermoplastic polyurethane having a nominal number average molecular weight of 60,000 to 100,000, n is 2, and L-R-S is a moiety of the formula —(OCH₂CH₂)_{y}N⁺[(CH₃)₂](CₓH₂ₓ₊₁) X⁻, wherein x is an integer from 6 to 22, y is an integer from 1 to 8, and X is a halogen atom.

10. The antimicrobially active polymer molecule of claim 9, wherein x is an integer from 8 to 18, y is an integer from 1 to 3, and X is a chlorine atom.

11. The antimicrobially active polymer molecule of claim 1, selected from the group consisting of compounds of the formula P-(L-R-S)₂ wherein P is a thermoplastic polyurethane having a nominal number average molecular weight of 10,000 to 300,000 and L-R-S is a moiety of the formula —(OCH₂CH₂)ₘN⁺[(CH₃)₂](CₓH₂ₓ₊₁) X⁻, wherein m is an integer of 1 to 3 and x is 8, 12, 16, or 18 and X is a chloride or bromide ion.

12. The antimicrobially active polymer molecule of claim 1, selected from the group consisting of compounds of the formula P-(L-R-S)ₙ wherein P is a thermoplastic polyurethane having a nominal number average molecular weight of 10,000 to 300,000, n is 2, and L-R-S is a moiety of the formula 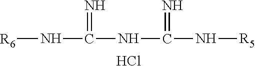
wherein R₆ is a group of the formula —O(CH₂)_{z}— in which z is an integer of from 1 to 18, covalently linking the biguanide moiety to the thermoplastic polyurethane, and R₅ is selected from the group consisting of straight or branched alkyl groups having 2 to 22 carbon atoms, aliphatic esters, aliphatic polyethers, fluorinated aliphatic polyethers, silicones, and silicone polyethers.

13. A medical device selected from the group consisting of urinary catheters, percutaneous catheters, central venous catheters, vascular access devices, intravenous delivery sites, drug delivery catheters, drains, gastric feeding tubes, tracheotomy tubes, contact lens, orthopedic implants, neuro-stimulation leads, pace maker leads, and blood bags, wherein said medical device comprises an antimicrobially active polymer in accordance with claim 1.

14. The medical device of claim 13, which is a central venous catheter or a urinary catheter.

15. A coating for hospital equipment or for a marine ship, comprising an antimicrobially active polymer according to claim 1.

16. An antimicrobially active polymer blend comprising a surface modifying antimicrobial polymer according to claim 1 as an additive.

17. A method of imparting an antimicrobial surface to a medical device or a coating, which method comprises the step of:
conducting an annealing treatment on a medical device according to claim 13 or on a coating according to claim 15, at a temperature 10° C. higher than the glass transition temperature of the polymer used to fabricate the medical device or coating and 30° C. below the melting temperature or softening temperature of the polymer used to fabricate the medical device or coating.

18. A method of imparting an antimicrobial surface to a medical device or a coating, which comprises the steps of:
melting a polymer according claim 1;
shaping the polymer melt into an a medical device or a coating; and
quenching the medical device or coating to solidify it into said medical device or coating have an antimicrobial surface.

19.-20. (canceled)
